(19) United States
(12) Patent Application Publication
(10) Pub. No.: US 2021/0079917 A1
(43) Pub. Date: Mar. 18, 2021

(54) GEAR PUMP AND GEAR MOTOR

(71) Applicant: SHIMADZU CORPORATION, Kyoto (JP)

(72) Inventor: Kazuma Murata, Kyoto (JP)

(73) Assignee: SHIMADZU CORPORATION, Kyoto (JP)

(21) Appl. No.: 16/835,321

(22) Filed: Mar. 31, 2020

(30) Foreign Application Priority Data
Sep. 12, 2019 (JP) 2019-166399

(51) Int. Cl. F04C 29/06; F04C 2/12

(52) U.S. Cl. CPC F04C 29/068; F04C 2/123

(57) ABSTRACT

Provided is a gear pump and a gear motor in which noise is reduced. A gear pump includes: gears which mesh and pair with each other; a casing including a gear housing chamber for housing the gears; and at least one hollow layer which is configured in the casing and divides the casing into at least inner walls and outer walls. Coincidence critical frequency of the inner walls and coincidence critical frequency of the outer walls are different. The hollow layer is formed between the gear housing chamber in the casing and an outer surface of the casing.

### CROSS-REFERENCE TO RELATED APPLICATION

This application claims the priority of Japan patent application serial no. 2019-166399, filed on Sep. 12, 2019. The entirety of the above-mentioned patent application is hereby incorporated by reference herein and made a part of this specification.

### BACKGROUND OF THE DISCLOSURE

### Technical Field

The disclosure relates to a gear pump and a gear motor.

### Related Art

Conventionally, various gear pumps or gear motors are developed and disclosed including the following patent literature 1. For example, a conventional gear pump 100 shown in FIG. 10 includes a drive gear 102, a driven gear 104, a drive shaft 106 formed integrally with the drive gear 102, a driven shaft 108 formed integrally with the driven gear 104, a gear housing chamber 110 in which the drive gear 102 and the driven gear 104 are housed, and a casing 114 including bearing holes 112 in which each of the shafts 106 and 108 is housed. The casing 114 is divided into a body 116 and a front 118, and the gear housing chamber 110 is formed in the body 116. As shown in FIG. 11, in the body 116, a suction passage 118 for introducing liquid (hydraulic oil) into the gear housing chamber 110 and a discharge passage 120 for discharging the liquid are formed. If the drive shaft 106 is rotated, the drive gear 102 and the driven gear 104 are rotated, and the liquid flows from the suction passage 118 to the discharge passage 120.

### LITERATURE OF RELATED ART

### Patent Literature

[Patent literature 1] EP1291526A2

The gear pump 100 is used to supply liquid to a liquid-pressure (oil-pressure) cylinder. Because the liquid is sent to the liquid hydraulic cylinder under pressure, vibration is generated when the drive gear 102 and the driven gear 104 mesh. The vibration is a cause of noise of the gear pump 100. If the mass of the casing 114 is increased, the noise is reduced by the increased amount. However, the casing 114 is significantly heavier, and the price of the gear pump 100 is also greatly increased, and thus it is unrealistic.

### SUMMARY

The gear pump or the gear motor according to one or some exemplary embodiments of the disclosure has a configuration as described below.

The gear pump or the gear motor of one or some exemplary embodiments of the disclosure includes: gears which mesh and pair with each other; a casing which includes a gear housing chamber for housing the gears; and at least one hollow layer which are configured in the casing and divides the casing into inner walls and outer walls.

### BRIEF DESCRIPTION OF THE DRAWINGS

FIG. 1 is a diagram showing a configuration of a gear pump of an embodiment of the application.

FIG. 2 is a front view in which a body having arc-shaped hollow layers configured therein are viewed from a cover.

FIG. 3 is a graph showing a coincidence effect.

FIG. 4 is an enlarged diagram of a square A in FIG. 1.

FIG. 5 is a diagram of a body in which linear hollow layers are configured.

FIG. 6 is a diagram of a body in which four hollow layers are configured.

FIG. 7 is a diagram of a body in which hollow layers are doubled.

FIG. 8 is a diagram showing a configuration of a gear pump in which hollow layers are configured in a front of a casing.

FIG. 9 is a diagram showing a configuration of a gear pump including a casing which is divided into a body, a front, and a rear.

FIG. 10 is a diagram showing a configuration of a conventional gear pump.

FIG. 11 is a front view in which a conventional body is viewed from a cover.

### DESCRIPTION OF THE EMBODIMENTS

One or some exemplary embodiments of the disclosure provide a gear pump and a gear motor in which the noise is reduced.

According to one or some exemplary embodiments of the disclosure, by including the hollow layer in the casing, vibration propagated through the casing can be reduced. The noise is reduced by reducing the vibration of the casing.

Embodiments of the disclosure are described with reference to the drawings. In a plurality of the embodiments, the same components may be denoted by the same symbols and description is omitted.

### Embodiment 1

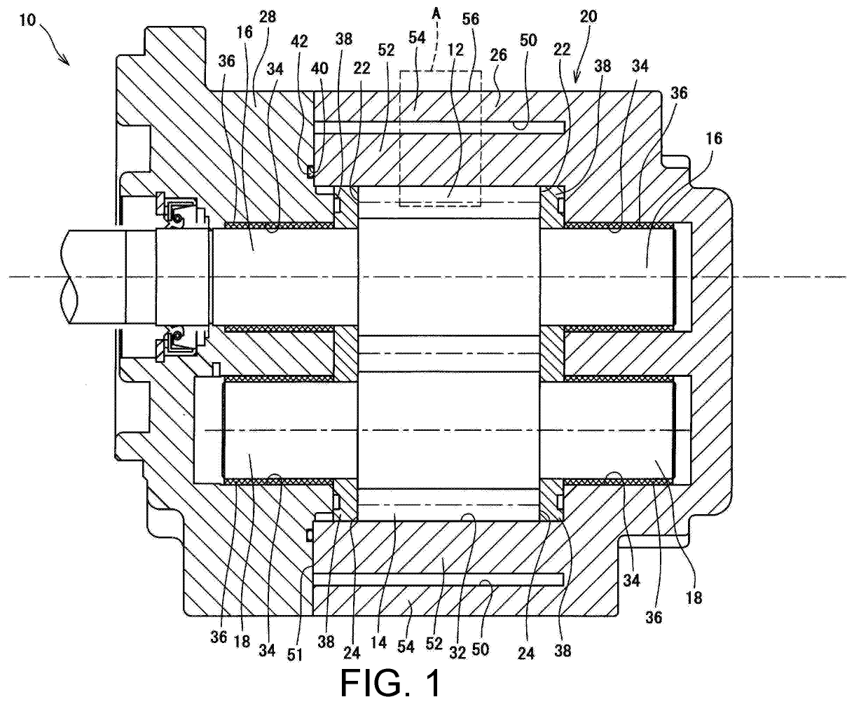

A gear pump 10 of the embodiment of the application shown in FIG. 1 includes gears 12, 14, shafts 16, 18 which can rotatably support the gears 12, 14, and a casing 20 in which the gears 12, 14 and the shafts 16, 18 are housed.

Gears are configured by the drive gear 12 and the driven gear 14 which are paired. Each of the gears 12, 14 has a plurality of teeth arranged at equal intervals. The drive gear 12 and the driven gear 14 mesh with each other, and the driven gear 14 is also rotated by the rotation of the drive gear 12.

The drive shaft 16 is formed integrally with the drive gear 12. The drive shaft 16 is arranged perpendicular to a side surface 22 of the drive gear 12 from the center of the side surface 22. In addition, the driven shaft 18 is formed integrally with the driven gear 14. The driven shaft 18 is arranged perpendicular to a side surface 24 of the driven gear 14 from the center of the side surface 24.

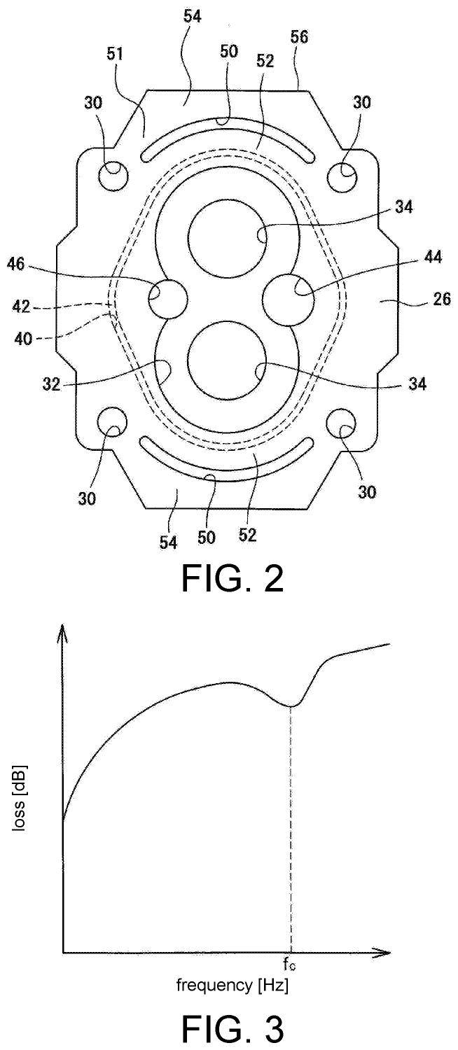

The casing 20 includes a body 26 and a front 28. The body 26 and the front 28 include holes 30 into which fasteners such as bolts are inserted, and the body 26 and the front 28 are fixed by the fasteners such as the bolts (FIG. 2). A gear housing chamber 32 is formed inside the body 26. The drive gear 12 and the driven gear 14 are housed in the gear housing chamber 32. The gear housing chamber 32 is closed by the front 28.

Bearing holes 34 are formed in the body 26 and the front 28, and the bearing holes 34 are connected to the gear housing chamber 32. The drive shaft 16 and the driven shaft 18 are passed through the bearing holes 34 via bushes 36. Side plates 38 are arranged in contact with the side surfaces 22, 24 of the gears 12, 14. The side plates 38 are plates having good slidability. The gears 12, 14 are rotated while the side surfaces 22, 24 are in contact with the side plates 38.

In the front 28, an annular groove 40 is formed outside the gear housing chamber 32. A gasket 42 is fitted in the groove 40. The gasket 42 is configured by elastomer, and the gasket 42 is in close contact with the body 26 and the front 28. The gasket 42 prevents liquid from leaking from a gap between the body 26 and the front 28.

A suction passage 44 and a discharge passage 46 are formed in the casing 20 (FIG. 2). Liquid (hydraulic oil) is sucked from the suction passage 44 to the gear housing chamber 32, and the liquid is discharged from the gear housing chamber 32 through the discharge passage 46. If the drive shaft 16 is rotated, the drive gear 12 and the driven gear 14 are rotated, and the liquid flows from the suction passage 44 to the discharge passage 46.

The body 26 includes hollow layers 50. The hollow layers 50 are deep grooves formed in the body 26. The hollow layers 50 are formed from a contact surface 51 of the body 26 with the front 28 to an opposite side of the front 28. There is air inside the hollow layers 50. The body 26 is divided into inner walls 52 and outer walls 54 by the hollow layers 50. The inner walls 52 are closer to the gear housing chamber 32 than the hollow layers 50, and the outer walls 54 are closer to an outer surface 56 of the body 26 than the hollow layers 50. The hollow layers 50 are formed closer to the outer surface 56 than the gasket 42. The liquid does not enter the hollow layers 50. Vibration transmitted through the inner walls 52 is propagated to the outer walls 54 via the hollow layers 50. At this time, the vibration is weakened by the hollow layers 50, and the vibration transmitted to the outer walls 54 is attenuated. The vibration of the body 26 is weakened, and the noise is reduced.

The body 26 is produced by casting, and thus parts which become the hollow layers 50 are formed in the mold in advance. The body 26 can be produced in the same production method as before.

A certain substance resonates with sound (vibration) of a predefined frequency, loss is reduced, and the sound of the frequency is easy to propagate through the substance (a coincidence effect). A frequency of sound which is propagated most easily is a coincidence critical frequency f_{c} (FIG. 3). In the embodiment of the application, coincidence critical frequencies f_{c} of the inner walls 52 and the outer walls 54 are made different. Sound having a frequency which resonates at the inner walls 52 is hard to resonate at the outer walls 54. Sound which can reach the surface 56 of the outer walls 54 can be reduced.

When a sound speed is set as c (m/s), a thickness of the substance is set as h (m), density of the substance is set as ρₘ (kg/m³), a Young's modulus of the substance is set as E (N/m²), and a Poisson's ratio of the substance is set as σ, the coincidence critical frequency f_{c} is as follows.

$${f}_{c} = \frac{{c}^{2}}{2 π h} \sqrt{\frac{12 {ρ}_{m} ( 1 - {σ}^{2} )}{E}} \qquad [ Formula 1 ]$$

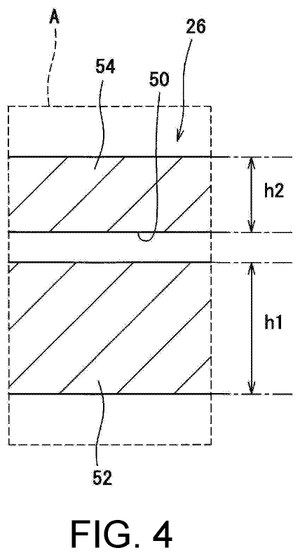

The coincidence critical frequency f_{c} is inversely proportional to the thickness h. Therefore, in order to make the coincidence critical frequencies f_{c} of the inner walls 52 and the outer walls 54 different, a thickness h1 of the inner walls 52 and a thickness h2 of the outer walls 54 are made different (FIG. 4). The coincidence critical frequencies f_{c} of the inner walls 52 and the outer walls 54 are different, and it is hard for the sound passing through the inner walls 52 to pass through the outer walls 54.

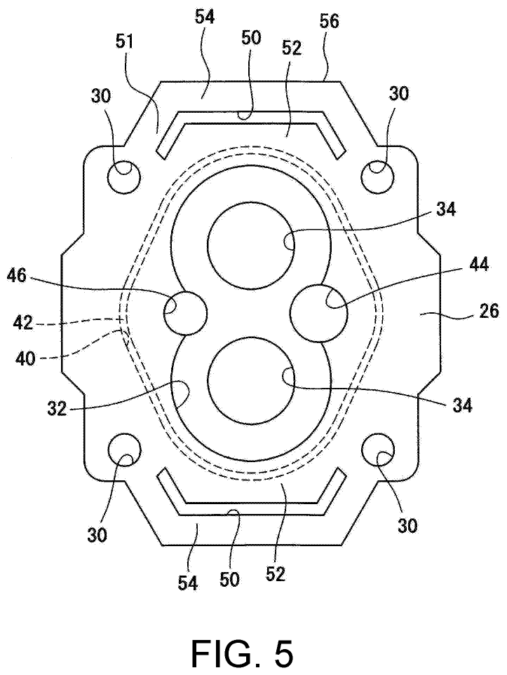

A shape of the hollow layers 50 when the gear housing chamber 32 of the body 26 is viewed from the front 28 is not limited to an arc shape (FIG. 2), a linear shape (FIG. 5), a combination thereof, or the like. The shape of the hollow layers 50 is not particularly limited as long as the inner walls 52 and the outer walls 54 are formed by the hollow layers 50.

A depth of the hollow layers 50 is the same as or deeper than a depth of the gear housing chamber 32. Therefore, the hollow layers 50 are arranged between the gear housing chamber 32 and the outer surface 56 of the body 26. The vibration is generated easily when the gears 12, 14 inside the gear housing chamber 32 mesh, and the vibration is transmitted from the gear housing chamber 32 to the body 26. Because the hollow layers 50 are between the gear housing chamber 32 and the outer surface 56 of the body 26, the vibration is attenuated easily by the hollow layers 50.

As described above, in the embodiment of the application, the hollow layers 50 are formed in the body 26 of the casing 20, and thus the vibration propagated through the body 26 can be attenuated. The noise generated by the vibration of the body 26 can be reduced. The thickness of the casing 20 is not increased as much as twice or the like, and weight increase is also small.

### Embodiment 2

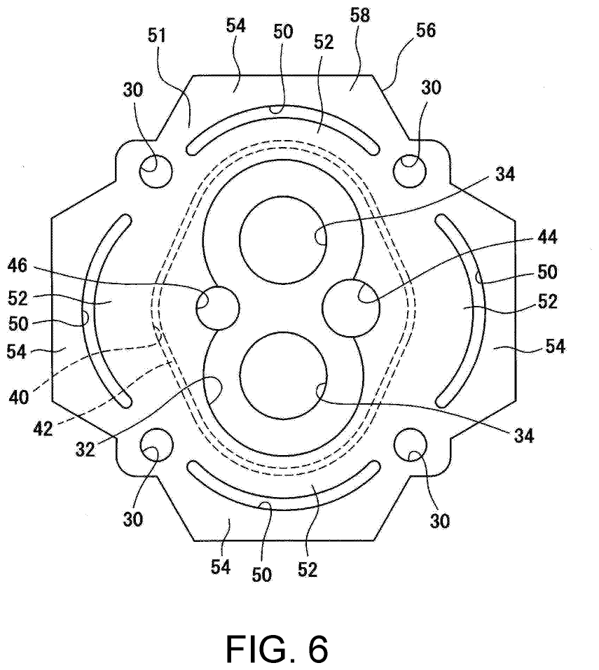

As in a body 58 of FIG. 6, hollow layers 50 may be arranged on four sides. The hollow layers 50 can be formed as long as there is no obstacle such as holes 30 into which fasteners in the body 58 are inserted, a suction passage 44, a discharge passage 46 and the like for forming the hollow layers 50.

### Embodiment 3

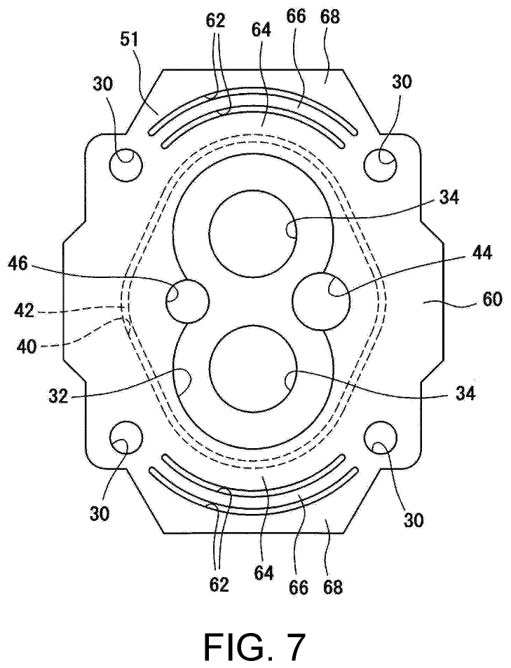

A body 60 in FIG. 7 has doubled hollow layers 62. Inner walls 64, middle walls 66 and outer walls 68 are formed in the body 60 by the hollow layers 62. Thicknesses of the inner walls 64, the middle walls 66 and the outer walls 68 are changed to make coincidence critical frequencies f_{c} different. A frequency band of vibration to be attenuated is widened, and silencing effect is enhanced.

### Embodiment 4

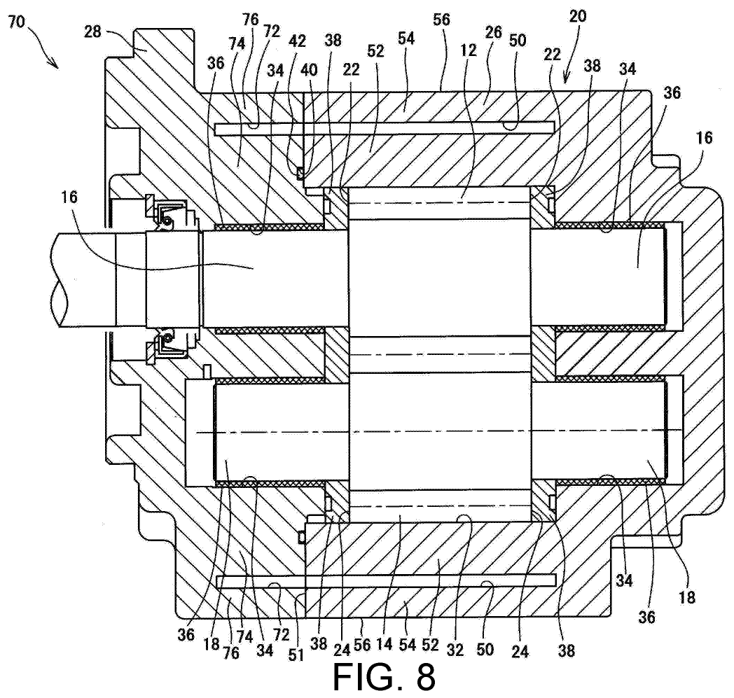

As in a gear pump 70 in FIG. 8, hollow layers 72 may be formed in the front 28 of the casing 20. Parts where vibration is attenuated by the hollow layers 50 of the body 26 and the hollow layers 72 of the front 28 become large. Vibration is attenuated easily, and sound is silenced easily. In the front 28, thicknesses of inner walls 74 and outer walls 76 may also be made different in a manner that coincidence critical frequencies f_{c} of the inner walls 74 and the outer walls 76 are different.

### Embodiment 5

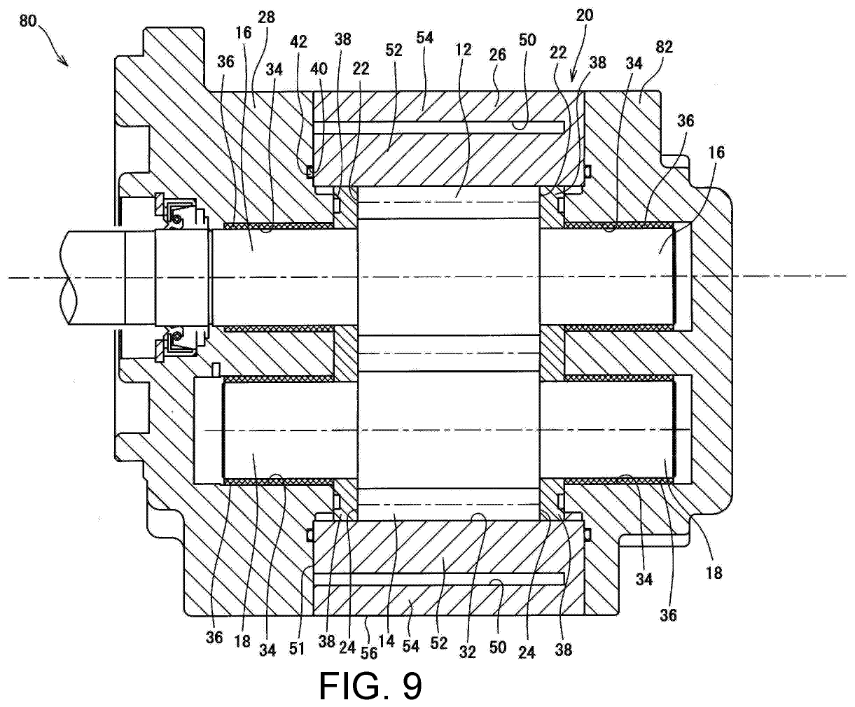

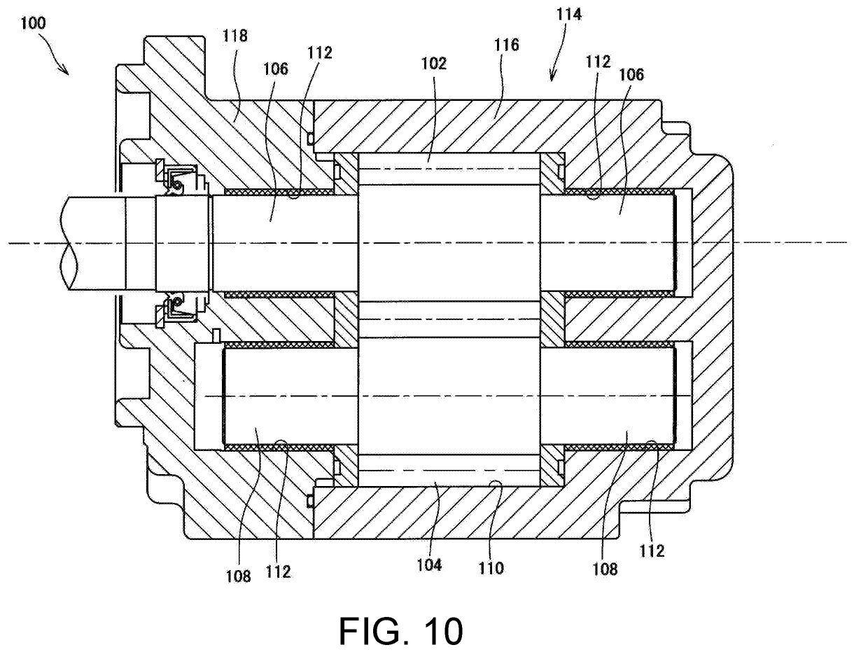

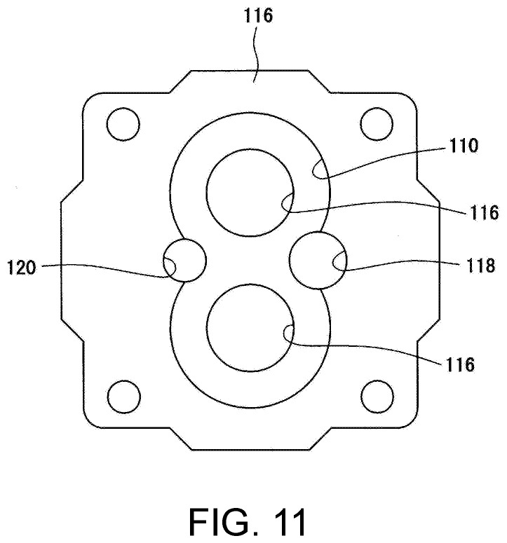

In a gear pump 80 in FIG. 9, the casing 20 is divided into the body 26, the front 28 and a rear 82. The gear housing chamber 32 is formed in the body 26, and the gear housing chamber 32 is blocked by the front 28 and the rear 82. The embodiment of the application also includes hollow layers 50 in the aforementioned casing 20. If hollow layers 50 are formed in the body 26 as shown in FIG. 9, hollow layers may or may not be formed in the front 28 and the rear 82.

### Embodiment 6

A gear motor of the embodiment of the application can be configured with the same structure as the gear pump 10 described in the above embodiments.

(Item 1) A gear pump or a gear motor includes: gears which mesh and pair with each other; a casing which includes a gear housing chamber for housing the gears; and hollow layers which are formed in the casing and divide the casing into at least inner walls and outer walls.

According to the gear pump or the gear motor of item 1, the hollow layers are formed in the casing, and thus vibration propagated through the casing is hard to propagate by the hollow layers. The vibration of the casing is reduced, and noise is reduced.

(Item 2) Coincidence critical frequencies of the inner walls and the outer walls are different.

According to the gear pump or the gear motor of item 2, the coincidence critical frequencies of the inner walls and the outer walls are different, and thereby it is hard for vibration passing through the inner walls to pass through the outer walls. The vibration of the casing can be reduced.

(Item 3) The hollow layers are formed between the gear housing chamber in the casing and an outer surface of the casing.

According to the gear pump or the gear motor of item 3, although vibration is generated due to the meshing of the gears arranged in the gear housing chamber, the hollow layers are arranged at places where the vibration is propagated most strongly, and the noise is easily reduced.

(Item 4) A plurality of the hollow layers is formed.

According to the gear pump or the gear motor of item 4, there is a plurality of hollow layers, and thereby parts with reduced sound transmitted through the casing are increased, and the noise is easily reduced.

Additionally, the disclosure can be implemented with aspects in which various improvements, modifications, and changes are made based on knowledge of those skilled in the art without departing from the gist of the disclosure.

What is claimed is:

1. A gear pump comprising:
gears which mesh and pair with each other;
a casing which comprises a gear housing chamber for housing the gears; and
at least one hollow layer which is configured in the casing and divides the casing into at least inner walls and outer walls.

2. The gear pump according to claim 1, wherein coincidence critical frequency of the inner walls and coincidence critical frequency of the outer walls are different.

3. The gear pump according to claim 1, wherein the hollow layer is configured between the gear housing chamber in the casing and an outer surface of the casing.

4. The gear pump according to claim 2, wherein the hollow layer is configured between the gear housing chamber in the casing and an outer surface of the casing.

5. The gear pump according to claim 1, wherein the at least one hollow layer comprises a plurality of the hollow layers.

6. The gear pump according to claim 2, wherein the at least one hollow layer comprises a plurality of the hollow layers.

7. The gear pump according to claim 3, wherein the at least one hollow layer comprises a plurality of the hollow layers.

8. The gear pump according to claim 4, wherein the at least one hollow layer comprises a plurality of the hollow layers.

9. A gear motor comprising:
gears which mesh and pair with each other;
a casing which comprises a gear housing chamber for housing the gears; and
at least one hollow layer which is configured in the casing and divides the casing into at least inner walls and outer walls.

10. The gear motor according to claim 9 wherein coincidence critical frequency of the inner walls and coincidence critical frequency of the outer walls are different.

11. The gear motor according to claim 9, wherein the hollow layer is configured between the gear housing chamber in the casing and an outer surface of the casing.

12. The gear motor according to claim 10, wherein the hollow layer is configured between the gear housing chamber in the casing and an outer surface of the casing.

13. The gear motor according to claim 9, wherein the at least one hollow layer comprises a plurality of the hollow layers.

14. The gear motor according to claim 10, wherein the at least one hollow layer comprises a plurality of the hollow layers.

15. The gear motor according to claim 11, wherein the at least one hollow layer comprises a plurality of the hollow layers.

16. The gear motor according to claim 12, wherein the at least one hollow layer comprises a plurality of the hollow layers.
